(19) United States
(12) Patent Application Publication
(10) Pub. No.: US 2007/0120817 A1
(43) Pub. Date: May 31, 2007

(54) Isotonic interface which is used to control a real or virtual object

(76) Inventors: Christophe Chaillou, Lille (FR); Francois Martinot, Lille (FR); Patricia Plenacoste, Lille (FR)

Correspondence Address: LADAS & PARRY LLP, 224 SOUTH MICHIGAN AVENUE, SUITE 1600, CHICAGO, IL, 60604, US

(21) Appl. No.: 10/581,149

(22) PCT Filed: Dec. 1, 2004
(86) PCT No.: PCT/FR04/03086

§ 371 Date: May 31, 2006

(30) Foreign Application Priority Data
Dec. 2, 2003 (FR) 0314114

(51) Int. Cl. G09G 5/00

(52) U.S. Cl. 345/156

(57) ABSTRACT

An isotonic interface for controlling a real or virtual object. The interface includes support means for supporting three pivot shafts, the axes of the first and second shafts being mutually parallel and perpendicular to the axis of the third shaft; handle means enabling each of said shafts to be pivoted; and measurement means for measuring the displacement of each of said shafts so as to enable a real or virtual object to be controlled in three degrees of freedom.

The present invention relates to a novel isotonic interface for controlling a real or virtual object.

The interface can be used as a computer peripheral enabling the user to manipulate objects in a virtual environment, or more broadly enabling the user to modify said virtual environment.

Although more particularly provided for such applications, the isotonic interface could also be used for controlling real objects enabling mechanical devices such as manipulator arms, robots, or other similar devices to be manipulated directly or remotely.

It is important to observe that the term “isotonic interface for controlling a real or virtual object” is used to mean any interface in which it is the displacements of its various members that are measured, as contrasted with measuring the forces transmitted by the user to said members, the interface opposing zero or constant resistance to any displacement imparted by the user.

Various types of isotonic interface already exist and they can be classified into two categories, interfaces that are tied to the user and interfaces that are not tied.

The present invention relates to the second category, i.e. only one end of the interface is connected to the user.

In practice, the interface is secured to the real environment, i.e. it is placed or secured to an element such as a table, the ground, or a wall.

In this category of fixed-base interfaces, commonly known devices include a “mouse” or a related device such as a “trackball” even though said devices present isometric operation.

Nevertheless, even though they are very widespread, those devices suffer from various drawbacks, and in particular they do not enable real or virtual objects to be controlled intuitively with three degrees of freedom.

Joystick-type devices are also known comprising a structure with three axes of rotation that can be controlled by a fist.

Nevertheless, the structure of joysticks with mutually perpendicular axes of rotation means that the position of the effectors is high and it is not possible for the user to rest the forearm in a stationary position and to manipulate the interface by moving the hand only.

Consequently, such devices are not adapted to lengthy or continuous control work.

An aim of the present invention is to mitigate the above-mentioned drawbacks and to propose an isotonic interface enabling real or virtual objects to be controlled with three degrees of freedom.

Another aim of the present invention is to provide an isotonic interface capable of being used without requiring the user to move the forearm.

Another aim of the present invention is to propose an isotonic interface enabling virtual or real objects to be controlled intuitively relative to the movements performed by the user.

The invention thus provides an isotonic interface for controlling a real or virtual object.

According to the invention, the interface comprises:

support means for supporting three pivot shafts, the axes of the first and second shafts being mutually parallel and perpendicular to the axis of the third shaft;

handle means enabling each of said shafts to be pivoted; and

measurement means for measuring the displacement of each of said shafts so as to enable a real or virtual object to be controlled in three degrees of freedom.

Other characteristics and advantages of the invention appear more clearly on reading the following description of a preferred embodiment, which description is given purely by way of non-limiting example and with reference to the accompanying drawings, in which:

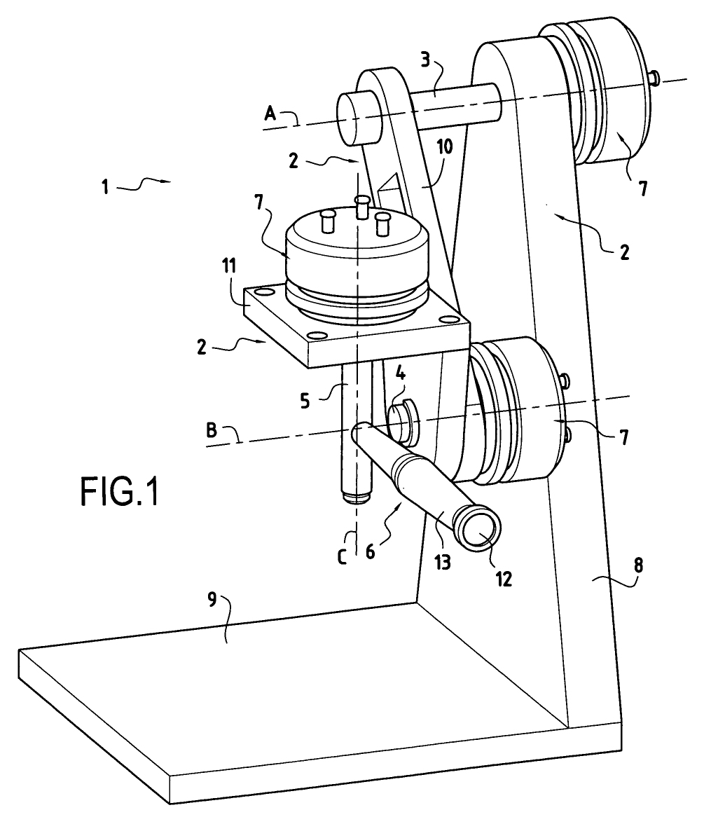

FIG. 1 is a perspective view of an embodiment of said isotonic interface in accordance with the invention;

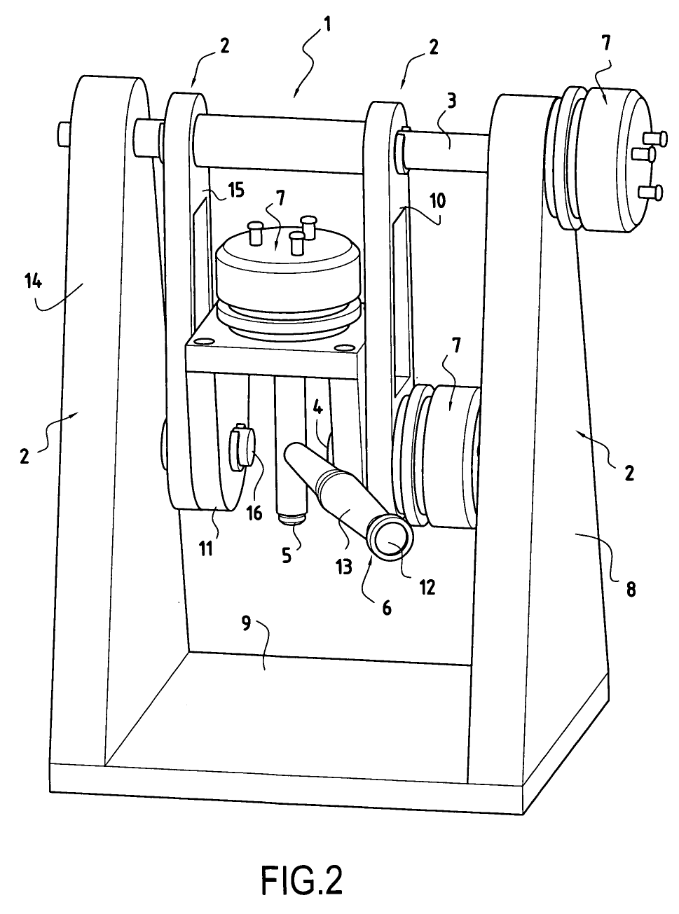

FIG. 2 is a perspective view of a second embodiment of the isotonic interface in accordance with the invention; and

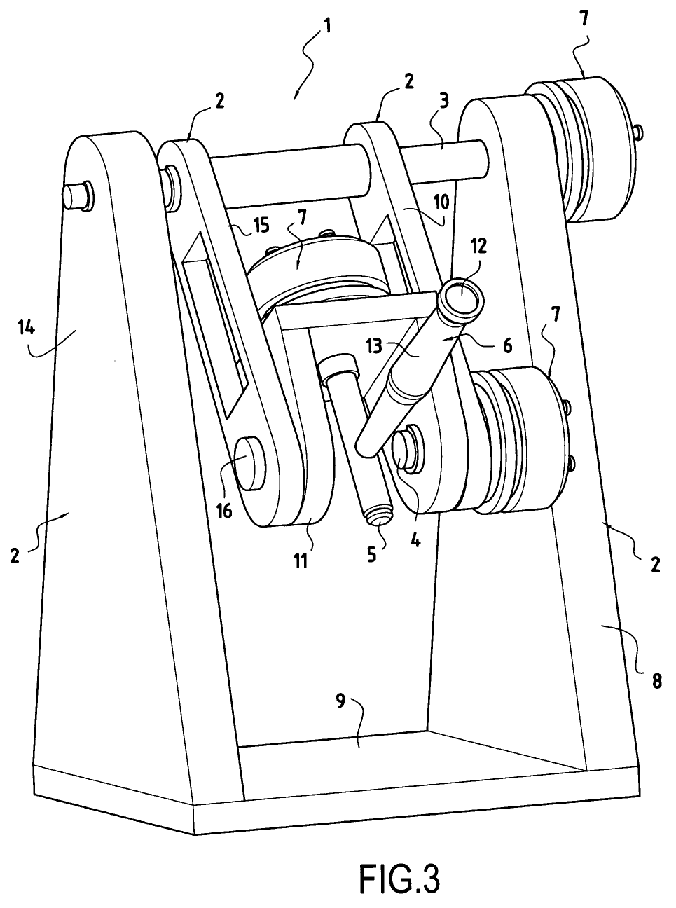

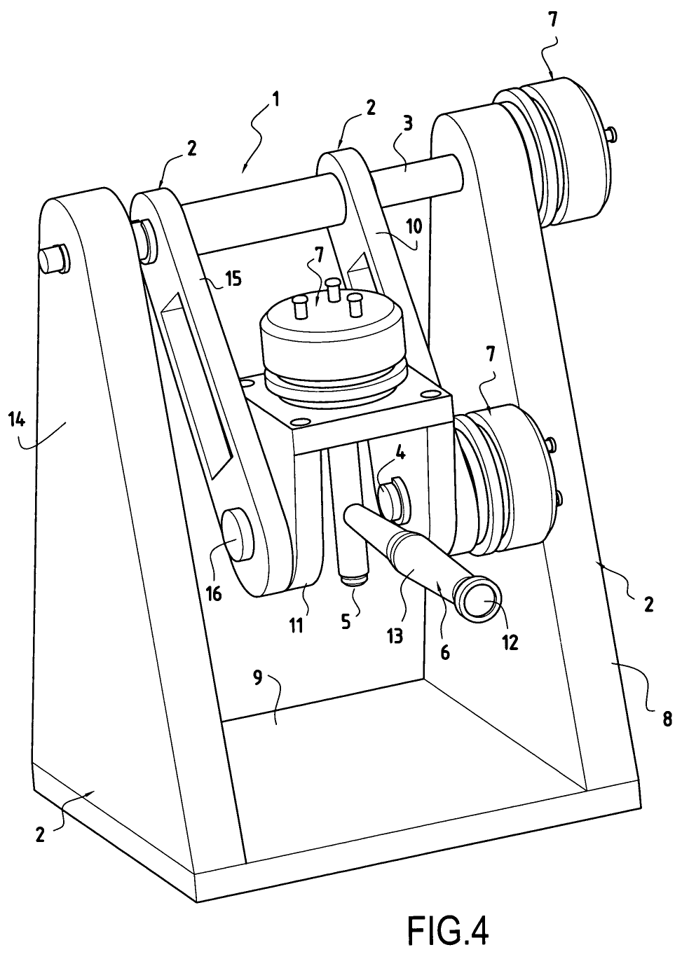

FIGS. 3 and 4 show two particular positions of the isotonic interface of the second embodiment shown in FIG. 2.

With reference mainly to FIG. 1 showing a first embodiment of the isotonic interface 1, it can be seen that the interface comprises support means 2 for three pivot shafts 3, 4, and 5, with the axes of the first and second shafts being parallel to each other and perpendicular to the axis of the third.

Said interface 1 also comprises handle means 6 enabling each of said three shafts 3, 4, and 5 to be pivoted.

Said interface 1 also comprises measurement means 7 for measuring the displacement of each of said shafts 3, 4, and 5 so as to enable a real or virtual object to be controlled with three degrees of freedom.

In the embodiments of FIGS. 1 to 4, said measurement means 7 are constituted by angular position sensors, e.g. potentiometers, placed on the various shafts.

Nevertheless, other devices for measuring displacement could equally well be envisaged, and in particular optical sensors.

In the first embodiment, the support means 2 comprise a support element 8 secured to a base 9 and connected to the first shaft 3 via a first pivot connection.

Said support element 8 preferably has a profile of triangular shape including a bore at its top for passing said first shaft 3.

Means are also provided for blocking said shaft 3 against moving in translation relative to said support element 8.

The shaft 3 is thus free to turn in the support element 8 about a first axis A.

Naturally, other embodiments of the pivot connection known to the person skilled in the art could be used, and in particular a connection made from a shaft and a smooth bearing or a ball bearing.

Said support means 2 further comprise an arm 10 secured perpendicularly to the first shaft 2 and connected to the second shaft 4 by a second pivot connection.

The second pivot connection could be made identically to the first pivot connection, i.e. said arm 10 includes a bore in which said second shaft 4 is inserted and prevented from moving in translation relative to said arm 10.

Here also, this is merely one example of an embodiment of the pivot connection amongst others that could be envisaged.

Said support means 2 further comprise a connection element 11 secured to the second shaft 4 and connected via a third pivot connection to said third shaft 5.

In the example of FIG. 1, said connection element 11 is constituted by two perpendicular branches, one of the branches being secured to the second shaft 4 and the other branch having an opening serving as a pivot connection for said third shaft 5 in a manner identical to the first and second pivot connections.

As mentioned above, said interface 1 also includes handle means 6 enabling each of said three arms 3, 4, and 5 to be turned in rotation.

These handle means 6 comprise a rod 13 whose distal end is secured to the third shaft 5.

In the embodiments of FIGS. 1 to 4, said handle means 6 further comprise an endpiece 12 disposed at the proximal end of the rod 13.

This endpiece 12 is designed to make the rod 13 easier to hold in the hand by enabling it to be grasped prismatically.

With reference to FIGS. 1 to 4, it can be seen that the distal end of the rod 13 is disposed at the intersection between the axes of rotation B and C of the second and third shafts 4 and 5.

This disposition makes it easier for the user to control the rotation of the various shafts.

FIG. 2 shows a second embodiment in accordance with the invention.

In this second embodiment, said support means 2 include additional elements compared with the above-described first embodiment for the purpose of increasing the stability of said interface 1.

To this end, provision is made for the support means 2 to have a second support element 14 secured to the base 9 and connected to the first shaft 3 by a pivot connection.

Said second support element 14 is preferably made identically to the support element 8.

In this second embodiment, provision is advantageously made for the support means 2 also to include a second arm 15 parallel to the arm 10 that is secured to the first arm 3 and connected to said link element 11 via a fourth shaft 16.

In this embodiment, said connection element 11 is U-shaped with one of the two branches of the U-shape connected to the second shaft 4 and the other to the fourth shaft 16.

The portion interconnecting the two branches serves as a support for the third shaft 5, leaving it free in rotation.

According to the invention, said handle means 6 enable each of said shafts 3, 4, and 5 to be pivoted.

With reference to FIG. 2, it can be seen that when said handle means are moved circularly to the right, they drive solely the shaft 5 in rotation about its axis C.

With reference to FIG. 3, it can be seen that said handle means 6 have been moved circularly vertically upwards and in depth in a rearwards direction.

The vertical circular displacement serves to rotate the second shaft 4 about its axis B, while the circular movements in depth serve to rotate said first shaft 3 about its axis A.

It is quite possible for a user to control displacement about one or more axes depending on the command the user wishes to issue.

Thus, in FIG. 4, it can be seen that the user is imparting vertical downward movement, causing the second shaft 4 to pivot in one direction, while simultaneously imparting rearward movement to cause said first shaft to pivot in another direction.

The structure of the interface 1 with two mutually parallel axes of rotation perpendicular to a third axis makes it possible to limit the amplitude of the displacements the user needs to perform, so the user can keep a forearm stationary.

Numerous tests have been carried out for also defining the dimensional characteristics of the various elements and for providing an ergonomic configuration for the user.

Thus, the height of the support element 8 preferably lies in the range 100 millimeters (mm) to 130 mm, and is advantageously 115 mm.

The length of the arm 10 preferably lies in the range 50 mm to 60 mm, and is advantageously 55 mm.

The length of the rod 13 lies in the range 70 mm to 90 mm, and is advantageously 80 mm.

It is important to emphasize that the interface 1 advantageously includes means for holding it in position.

Such position-holding means enable the user to let go the interface 1 without it moving significantly away from its latest position.

This characteristic is particularly advantageous in that it limits user fatigue by reducing the forces that need to be applied to the moving portions when applying actions or relaying interactions.

It also makes it possible to avoid losing position information when the user returns to a task.

For this purpose, provision is made for the position-holding means to comprise a counterweight disposed behind the rod 13 and serving to counterbalance its weight.

The counterweight enables the rod 13 to be held in a horizontal position without the user performing any action and reduces the torque suffered by the axis when said rod 13 is moved vertically away from its equilibrium position.

In order to enable position to be held about each of the axes, bearings are used that enable the various shafts 3, 4, and 5 to pivot that are dimensioned in such a way that the axis slides inside it and is subjected to friction torque that is as small as possible. These elements are associated with passive brake means on each of the axes serving to generate friction torque that is greater than the torques generated on the various axes due to the action of gravity.

These passive brake means enable the rod to be held stationary whenever it is not being actuated, and they oppose constant low resistance to the displacement forces exerted by the user.

In particular, the brake means may be implemented on the basis of the plane friction of Belleville spring washers compressed by a nut and held stationary by a lock nut. The distribution of clamping angles should be designed to preserve an isotropic sensation.

It should also be observed that the gantry disposition also contributes to holding the position of the rod 13 in the sense that it makes it possible to work about a natural equilibrium position in which gravity forces are minimized.

Said isotonic interface 1 is particularly adapted to controlling the position of an object, i.e. so that a displacement of the handle means corresponds to a proportional displacement of the object.

That said, it is also possible to envisage using the isotonic interface 1 for controlling the velocity of an object, in which case a displacement of the handle means 6 corresponds to a speed command in a given direction for the object.

When using the interface 1 as a position control device, functions are defined by converting angles α, β, and γ corresponding respectively to the measured angles of rotation about the first, second, and third axes into X, Y, and Z coordinates in a rectangular frame of reference (O,x,y,z).

The following functions are preferably used:
X=−sin β×a
(where a corresponds to the length of the rod 13);
Y=cos(α+γ)×cos β×a+sin α×b−a
(where b corresponds to the distance between the first and second pivot connections); and
Z=b×cos α−b×sin(α+γ)×cos β×a−b

Nevertheless, that is merely an example of transformation functions, and many other functions could be envisaged.

It is also important to observe that the interface may have drive means (not shown in the accompanying drawings) serving to apply force return to the interface 1.

Such means could be implemented in particular by a motor disposed on one or more of the shafts 1, 2, 3, or 4 and exerting torque on the corresponding shafts as a function of the real or virtual environment in which the interface 1 acts.

Provision can also be made for additional means to be provided on the handle means 6 for controlling the real or virtual object, enabling the real or virtual object to be controlled in at least one additional degree of freedom.

Advantageously, such means are constituted by a pushbutton disposed on the endpiece 12.

Naturally, other embodiments within the competence of the person skilled in the art could be envisaged without thereby going beyond the ambit of the invention defined by the following claims.

1. An isotonic interface for controlling a real or virtual object, the interface comprising:
support means for supporting three pivot shafts the axes of the first and second shafts being mutually parallel and perpendicular to the axis of the third shaft;
handle means enabling each of said shafts to be pivoted; and
measurement means for measuring the displacement of each of said shafts so as to enable a real or virtual object to be controlled in three degrees of freedom.

2. An isotonic interface according to claim 1, in which said support means comprise:
a support element secured to a base and connected to the first shaft via a first pivot connection;
an arm secured perpendicularly to the first shaft and connected to the second shaft via a second pivot connection; and
a connection element secured to the second shaft and connected to said third shaft via a third pivot connection.

3. An isotonic interface according to claim 2, in which said support means include a second support element secured to the base and connected to the first shaft via a pivot connection enabling the stability of the interface to be increased.

4. An isotonic interface according to claim 2, in which the support means include a second arm parallel to the first, secured to the first shaft and connected to said connection element via a fourth shaft.

5. An isotonic interface according to claim 1, in which the handle means comprise a rod having its distal end secured to the third shaft.

6. An isotonic interface according to claim 5, in which the handle means include an endpiece disposed at the proximal end of the rod and enabling it to be grasped prismatically.

7. An isotonic interface according to claim 5, in which the distal end of said rod is disposed at the interaction between the axes of rotation of the second and third shafts.

8. An isotonic interface according to claim 1, in which said measurement means are constituted by angular position sensors disposed on the first, second, and third shafts.

9. An isotonic interface according to claim 1, in which at least one of said shafts includes drive means enabling a force return to be applied to the interface.

10. An isotonic interface according to claim 2, in which the height of the support element lies in the range 100 mm to 130 mm.

11. An isotonic interface according to claim 2, in which the length of the arm lies in the range 50 mm to 60 mm.

12. An isotonic interface according to claim 5, in which the length of the rod lies in the range 70 mm to 90 mm.

13. An isotonic interface according to claim 1, in which provision is made for additional control means for controlling said real or virtual object, enabling said object to be controlled in at least one additional degree of freedom.

14. An isotonic interface according to claim 1, in which position-holding means are provided serving to avoid any significant departure of the rod from its most recent position when the user lets go the rod.

15. An isotonic interface according to preceding claim 14, in which the position-holding means comprise a counterweight and passive brake means.
